(19) United States
(12) Patent Application Publication
(10) Pub. No.: US 2024/0262760 A1
(43) Pub. Date: Aug. 8, 2024

(54) COMPOSITION FOR TREATING ORGANIC WASTE AND PRODUCTION OF LIQUID FERTILIZER

(71) Applicants: Gerry Hamaliuk, Oakville (CA); Joseph P. Baker, Oakville (CA)

(72) Inventors: Gerry Hamaliuk, Oakville (CA); Joseph P. Baker, Oakville (CA)

(21) Appl. No.: 18/681,916

(22) PCT Filed: Aug. 12, 2022
(86) PCT No.: PCT/CA2022/051232

§ 371 Date: Feb. 7, 2024

Related U.S. Application Data
(60) Provisional application No. 63/260,235, filed on Aug. 13, 2021.

(51) Int. Cl. C05F 9/04; C05F 17/20; C05F 17/40; C05G 5/20

(52) U.S. Cl. CPC C05F 9/04; C05F 17/20; C05F 17/40; C05G 5/20

(57) ABSTRACT

The present application relates to an organic material treatment composition and its use in a method for treating organic material digestate and in producing liquid fertilizer from organic material digestate. The method comprises mixing an organic material composition, incubating and agitating the organic material composition for 15 to 25 days at about 30° ° C. to 50° ° C. to produce a liquid fertilizer, wherein the organic material treatment composition has a pH of about 4 or less than 4. The liquid fertilizer can be used for the enhancement of plant growth and/or soil enrichment.

### CROSS-REFERENCE TO RELATED APPLICATIONS

The present application claims the benefit of priority from co-pending U.S. provisional patent application Ser. No. 63/260,235 filed on Aug. 13, 2021, the contents of which are incorporated herein by reference in their entirety.

### FIELD

The present application relates to an organic material treatment composition for treating organic waste digestate and producing liquid fertilizer and uses thereof. Further, the present application relates to methods of treating organic waste digestate and producing liquid fertilizer. The present application also relates to liquid fertilizer for agricultural and/or industrial use.

### INTRODUCTION

Organic waste such as food waste and municipal sewage waste remains an important environmental issue. Decomposing organic waste creates greenhouse gases and harmful pathogens that are a nuisance to the environment. On the other hand, organic waste contains material that when broken down represents for example, nitrogen and phosphorus-rich nutrients for plants. Organic material can be converted to fertilizing compositions useful in agricultural and/or garden settings. However, traditional treatment of organic material can include use of harsh chemicals that negate the environmental impact of treating organic waste.

There is a need to develop a method to treat organic material into a beneficial composition such as a fertilizer under mild environmentally favourable conditions.

### SUMMARY

It has been shown herein that the organic material treatment composition of the present application can be used to treat organic waste digestate including food waste digestate, sewage waste digestate, animal waste digestate, and agricultural waste digestate to produce a liquid fertilizer. In some embodiments, the liquid fertilizer as described herein is pathogen-free. Further, the liquid fertilizer of the present application is shown to be nitrogen-fixing, phosphorus solubilizing and potassium solubilizing. Accordingly, the liquid fertilizer of the present application can be used to enhance plant growth.

Accordingly, in one aspect, the present application includes a method of treating an organic material digestate and/or producing a liquid fertilizer comprising
mixing an organic material treatment composition, the organic material digestate, and water to obtain an organic digestate mixture; and
incubating and agitating the organic digestate mixture for about 15 days to about 25 days at about 30° C. to about 50° C. to treat the organic material digestate and/or to produce the liquid fertilizer;
wherein the organic material treatment composition comprises
   fruit skin;
   fermented rice water;
   milk;
   eggs; and
   a first carbohydrate;
and wherein the organic material treatment composition has a pH of about 4 or less than 4.

In another aspect, the present application includes a method of treating an organic material digestate and/or producing a liquid fertilizer comprising
combining fruit skin, fermented rice water, milk, eggs, and a first carbohydrate to obtain a first mixture;
incubating and agitating the first mixture for about 10 days to about 25 days at about 30° C. to about 40° C. until a pH value of about 4 or less than 4 to obtain an organic material treatment composition;
mixing the organic material treatment composition, the organic material digestate, and water to obtain an organic digestate mixture; and
incubating and agitating the organic digestate mixture for about 15 days to about 25 days at about 30° C. to about 50° C. to treat the organic material digestate and/or to produce the liquid fertilizer.

In another aspect, the present application includes a liquid fertilizer produced by a method of the present application.

In another aspect, the present application includes a use of a liquid fertilizer of the present application for enhancing plant growth.

In another aspect, the present application includes a method of enhancing plant growth contacting a plant with a liquid fertilizer of the present application.

In another aspect, the present application includes a use of a liquid fertilizer of the present application for providing nutrients and/or beneficial microbes to a soil in need thereof.

In another aspect, the present application includes a method of providing nutrients to a soil in need thereof comprising contacting the soil with a liquid fertilizer of the present application.

In another aspect, the present application includes a use of an organic material treatment composition of the present application for the treatment of organic material digestate.

In another aspect, the present application includes a use of an organic material treatment composition of the present application for the production of a liquid fertilizer from an organic material digestate

### DRAWINGS

The embodiments of the application will now be described in greater detail with reference to the attached drawings in which:

FIG. 1 shows pictures of Mandeville plants treated with an exemplary liquid fertilizer of the present application (left) or with a commercial fertilizer (right). The plants were treated every two weeks from mid-July to mid-September: Panel A shows a picture taken at end-July; Panel B shows a picture taken at mid-August; and Panel C shows a picture taken mid-September. Panel D shows a picture of the root system of the plants taken at mid-October.

FIG. 2 shows pictures of two groups of Impatiens plants treated with an exemplary liquid fertilizer of the present application (left) or with water as a negative control (right). The plants were treated from beginning of February to end of March: Panel A shows a picture taken at mid-February; Panel B shows a picture taken at end-March.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### DESCRIPTION OF VARIOUS EMBODIMENTS

### I. Definitions

Unless otherwise indicated, the definitions and embodiments described in this and other sections are intended to be applicable to all embodiments and aspects of the present application herein described for which they are suitable as would be understood by a person skilled in the art.

The term “and/or” as used herein means that the listed items are present, or used, individually or in combination. In effect, this term means that “at least one of” or “one or more” of the listed items is used or present.

As used in the present application, the singular forms “a”, “an” and “the” include plural references unless the content clearly dictates otherwise. For example, an embodiment including “a composition” should be understood to present certain aspects with one composition, or two or more additional compositions.

In embodiments comprising an “additional” or “second” component, such as an additional or second composition, the second component as used herein is chemically different from the other components or first component. A “third” component is different from the other, first, and second components, and further enumerated or “additional” components are similarly different.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “treatment of organic material digestate” or “to treat organic material digestate” or the like thereof as used herein means subjecting an organic material digestate to an action or a series of actions under conditions to chemically and/or biologically transform, modify, and/or break down the organic material digestate. For example, the action or the series of actions can include contacting the organic material digestate with another composition.

The term “enhancing plant growth” or the like thereof as used herein means improve the growth of a plant. For example, improvements of the growth of the plant can manifest in the form of increased foliage, root system, flowering, and/or fruit bearing. For example, a plant receiving a treatment to enhance plant growth can exhibit increased or more robust foliage, root system, flowering, and/or fruit bearing compared to a plant not receiving such treatment.

### II. Compositions of the Application

In one aspect, the present application includes a liquid fertilizer produced by a method of the present application.

In some embodiments, the liquid fertilizer of the present application is pathogen-free. By “pathogen-free” it is meant that the liquid fertilizer is substantially free of harmful pathogens. However, it can be appreciated that the liquid fertilizer of the present application can contain useful microorganisms. For example, useful microorganisms can include nitrogen, potassium, and/or phosphate fixing microbes.

### III. Methods and Uses of the Application

In another aspect, the present application includes a method of treating an organic material digestate and/or producing a liquid fertilizer comprising
mixing an organic material treatment composition, the organic material digestate, and water to obtain an organic digestate mixture; and
incubating and agitating the organic digestate mixture for about 15 days to about 25 days at about 30° C. to about 50° C. to treat the organic material digestate and/or to produce the liquid fertilizer;
wherein the organic material treatment composition comprises
   fruit skin;
   fermented rice water;
   milk;
   eggs; and
   a first carbohydrate;
and wherein the organic material treatment composition has a pH of about 4 or less than 4.

In another aspect, the present application includes a method of treating an organic material digestate and/or producing a liquid fertilizer comprising
combining fruit skin, fermented rice water, milk, eggs, and a first carbohydrate to obtain a first mixture;
incubating and agitating the first mixture for about 10 days to about 25 days at about 30° C. to about 40° C. until a pH value of about 4 or less than 4 is to obtain an organic material treatment composition;
mixing the organic material treatment composition, the organic material digestate, and water to obtain an organic digestate mixture; and
incubating and agitating the organic digestate mixture for about 15 days to about 25 days at about 30° C. to about 50° ° C. to treat the organic material digestate and/or to produce the liquid fertilizer.

In some embodiments, the method of the present application further comprises prior to incubating and agitating the organic digestate mixture, contacting the organic digestate mixture with a bacterial culture comprising Bacillus bacteria prior to the incubating and agitating, optionally, the organic material mixture is contacted with about 0.5 g to about 1.5 g of the bacterial culture per liter of water in the organic material mixture. In some embodiments, the Bacillus bacteria are selected from Bacillus pumilus, Bacillus subtilis, and mixtures thereof.

In some embodiments, the first mixture is incubated and agitated for about 12 days to about 23 days. In some embodiments, wherein the first mixture is incubated and agitated at about 35° C.

In some embodiments, the fruit skin is skin from fruits comprising ascorbic acid and/or citric acid. In some embodiments, the fruit skin is selected from skin from citrus fruit, pineapple, mango, papaya, dragon fruit, dates, lychee, tamarind, and mixtures thereof. In some embodiments, the citrus fruit is selected from orange, lemon, lime, grapefruit, pomelo, and mixtures thereof. In some embodiments, the fruit skin is skin from orange, lemon and pineapple. In some embodiments, if the fruit skin is a mixture of fruit skins the amount of each individual fruit skin is not critical and therefore each may be present in any ratio.

In some embodiments, the fermented rice water is obtained by fermenting a water used to wash rice. In some embodiments, the fermented rice water is fermented at a temperature of about 25° C. to about 40° C. In some embodiments, the fermented rice water is fermented at a temperature of about 30° C. to about 35° C. In some embodiments, the fermented rice water is fermented for about 50 hours to about 90 hours. In some embodiments, the fermented rice water is fermented for about 60 hours to about 80 hours. In some embodiments, the fermented rice water is fermented for about 70 hours to about 75 hours. In some embodiments, the fermented rice water is fermented for about 72 hours. In some embodiments, the fermented rice water is fermented under conditions until a mold can be observed on the surface of the fermented rice water.

In some embodiments, the milk is whole milk, partially skimmed milk, cream or mixtures thereof. In some embodiments, the milk is whole milk. In some embodiments, if the milk is a mixture of different milks, the amount of each individual milk is not critical and therefore each may be present in any ratio.

In some embodiments, the eggs are poultry eggs. In some embodiments, the poultry eggs are selected from chicken eggs, duck eggs, goose eggs, and mixtures thereof. In some embodiments, the eggs are beaten. In some embodiments, if the eggs are a mixture of eggs from different animals, the amount of each individual egg is not critical and therefore each may be present in any ratio.

In some embodiments, the first carbohydrate is selected from molasses, brown sugar, white sugar, cane sugar, honey, corn syrup, and mixtures thereof.

In some embodiments, the first carbohydrate is selected from molasses, brown sugar and mixtures thereof. In some embodiments, if the first carbohydrate is a mixture of carbohydrates the amount of each individual first carbohydrate is not critical and therefore each may be present in any ratio.

In some embodiments, the organic material treatment composition comprises about 4 wt % to about 7 wt % of the fruit skin. In some embodiments, the organic material treatment composition comprises about 5 wt % to about 5.5 wt % of the fruit skin.

In some embodiments, the organic material treatment composition comprises about 8 wt % to about 14 wt % of the fermented rice water. In some embodiments, the organic material treatment composition comprises about 9 wt % to about 12 wt % of the fermented rice water.

In some embodiments, the organic material treatment composition comprises about 4 wt % to about 7 wt % of the milk. In some embodiments, the organic material treatment composition comprises about 5 wt % to about 5.5 wt % of the milk.

In some embodiments, the organic material treatment composition comprises about 0.5 wt % to about 5 wt % of the eggs. In some embodiments, the organic material treatment composition comprises about 1.5 wt % to about 4.5 wt % of the eggs.

In some embodiments, the organic material treatment composition comprises about 67 wt % to about 83.5 wt % of the first carbohydrate.

In some embodiments, the organic material treatment composition comprises about 70 wt % to about 80 wt % of the first carbohydrate.

In some embodiments, the organic material treatment composition of the present application comprises
about 5 wt % to about 5.5 wt % of the fruit skin;
about 9 wt % to about 12 wt % of the fermented rice water;
about 5 wt % to about 5.5 wt % of the milk;
about 1.5 wt % to about 4.5 wt % of the eggs; and
about 70 wt % to about 80 wt % of the first carbohydrate.

In some embodiments, the incubating and agitating of the first mixture further comprises combining the incubated and agitated first mixture with a second carbohydrate and at least one selected from water, an organic waste leachate and mixtures thereof to obtain a second mixture, and incubating and agitating the second mixture for 5 to 15 days at about 20° C. to about 28° C. to obtain the organic material treatment composition.

In some embodiments, the incubating and agitating of the second mixture is for about 7 days to about 12 days. In some embodiments, the incubating and agitating of the second mixture is about 21° C. to about 25° C.

In some embodiments, the organic material treatment composition of the present application further comprises a second carbohydrate and water.

In some embodiments, the second carbohydrate selected from molasses, brown sugar, white sugar, cane sugar, honey, corn syrup, and mixtures thereof. In some embodiments, the second carbohydrate is selected from molasses, brown sugar and mixtures thereof. In some embodiments, if the second carbohydrate is a mixture of carbohydrates the amount of each individual second carbohydrate is not critical and therefore each may be present in any ratio.

In some embodiments, the first carbohydrate and the second carbohydrate are the same.

In some embodiments, the organic material treatment composition comprises about 0.5 wt % to about 2 wt % of the fruit skin. In some embodiments, the organic material treatment composition comprises about 1 wt % to about 1.7 wt % of the fruit skin.

In some embodiments, the organic material treatment composition comprises about 1 wt % to about 4 wt % of the fermented rice water. In some embodiments, the organic material treatment composition comprises about 2 wt % to about 3 wt % of the fermented rice water.

In some embodiments, the organic material treatment composition comprises about 0.5 wt % to about 2 wt % of the milk. In some embodiments, the organic material treatment composition comprises about 1 wt % to about 1.7 wt % of the milk.

In some embodiments, the organic material treatment composition comprises about 0.1 wt % to about 1.5 wt % of the eggs. In some embodiments, the organic material treatment composition comprises about 0.3 wt % to about 1 wt % of the eggs.

In some embodiments, the organic material treatment composition comprises about 12 wt % to about 22 wt % of the first carbohydrate. In some embodiments, the organic material treatment composition comprises about 15 wt % to about 20 wt % of the first carbohydrate.

In some embodiments, the organic material treatment composition comprises about 12 wt % to about 22 wt % of the second carbohydrate. In some embodiments, the organic material treatment composition comprises about 15 wt % to about 20 wt % of the second carbohydrate.

In some embodiments, the organic material treatment composition comprises balance water.

In some embodiments, the organic material treatment composition comprises
about 1 wt % to about 1.7 wt % of the fruit skin;
about 2 wt % to about 3 wt % of the fermented rice water;
about 1 wt % to about 1.7 wt % of the milk;
about 0.3 wt % to about 1 wt % of the eggs;
about 15 wt % to about 20 wt % of the first carbohydrate;
about 15 wt % to about 20 wt % of the second carbohydrate; and
balance water.

In some embodiments, the organic material digestate is a digestate of an organic waste selected from food waste, sewage waste, septic tank sludge, agricultural waste, farming waste, supermarket waste, restaurant waste, grocery store waste, food processing waste, animal manures, silage waste, composting waste, and mixtures thereof.

In some embodiments, the animal manures are farm animal manures such as cow manures. In some embodiments, the animal manures are zoo animal manures. It can be appreciated that animal is not limited to domestic animal and also includes exotic animal such as animals kept in zoos.

In some embodiments, the organic material digestate is an aerobic digestate.

In some embodiments, the organic material digestate is an anaerobic digestate, and the anaerobic digestate is aerated prior to the mixing with the organic material treatment composition and the water, optionally the aerating is performed with air injection.

In some embodiments, the anaerobic digestate is septic tank sludge digestate and/or human sewage digestate and has been digested in an anaerobic digester for about 15 to about 30 days.

In some embodiments, food waste digestate and has been digested in an anaerobic digester for about 10 days to about 40 days.

In some embodiments, the anaerobic digestate is animal manures digestate, silage waste digestate, food processing waste digestate, composting waste digestate, septic waste digestate, farm waste digestate, or mixtures thereof, and has been digested in an anaerobic digester for about 15 days to about 50 days.

In some embodiments, the organic material digestate has a solid content of about 2 v/v % to about 40 v/v %. In some embodiments, the solid content is about 4 v/v % to about 30 v/v %.

In some embodiments, the organic material digestate is a liquid digestate.

In some embodiments, the organic material digestate is a solid digestate and is diluted prior to the mixing with the organic material treatment composition and the water.

In some embodiments, the organic material digestate represents about 60 v/v % to about 90 v/v % of the total weight of the organic digestate mixture, the organic material treatment composition represents about 10 v/v % to about 40 v/v % of the total weight of the organic digestate mixture.

In some embodiments, the organic material digestate represents about 70 v/v % to about 85 v/v % of the total weight of the organic digestate mixture, the organic material treatment composition represents about 15 v/v % to about 30 v/v % of the total weight of the organic digestate mixture.

In some embodiments, the organic material digestate represents about 80 v/v % of the total weight of the organic digestate mixture, the organic material treatment composition represents about 20 v/v % of the total weight of the organic digestate mixture.

In some embodiments, the incubating and agitating the organic digestate mixture is for about 17 days to about 23 days. In some embodiments, the incubating and agitating the organic digestate mixture is at about 35° C. to about 45° C. For example, the incubating and agitating of the organic digestate mixture can be at about 40° C.

In some embodiments, the method of the present application further comprises pasteurizing the incubated and agitated organic digestate mixture.

It can be appreciated that the pasteurizing can be carried using methods known in the art. For example, the pasteurizing can be performed at about 70° C. for about 1 minute to about 10 minutes. For example, the pasteurizing can be performed for about 1 minute to about 3 minutes.

In another aspect, the present application includes a use of a liquid fertilizer of the present application for enhancing plant growth.

In another aspect, the present application includes a method of enhancing plant growth contacting a plant with a liquid fertilizer of the present application.

In another aspect, the present application includes a use of a liquid fertilizer of the present application for providing nutrients to a soil in need thereof.

In another aspect, the present application includes a method of providing nutrients to a soil in need thereof comprising contacting the soil with a liquid fertilizer of the present application.

In some embodiments, the liquid fertilizer is used in a diluted form. For example, the liquid fertilizer can be diluted with water. In some embodiments, the liquid fertilizer is diluted with water at a ratio of about 1:70 to about 1:200 by volume. In some embodiments, liquid fertilizer is diluted with water at a ratio of about 1:100 by volume.

In some embodiments, the liquid fertilizer is used once a week, every two weeks, or every three weeks. In some embodiments, the contacting of the liquid fertilizer with the plant is carried out once a week, every two weeks, or every three weeks. In some embodiments, the contacting of the liquid fertilizer with the soil is carried out once a week, every two weeks, or every three weeks.

In another aspect, the present application includes a use of an organic material treatment composition of the present application for the treatment of organic material digestate.

In another aspect, the present application includes a use of an organic material treatment composition of the present application for the production of a liquid fertilizer from an organic material digestate.

In some embodiments, the organic material treatment composition is used according to a method described herein. In some embodiments, the organic material treatment composition is as described herein. In some embodiments, the organic material digestate is as described herein.

### EXAMPLES

The following non-limiting examples are illustrative of the present application.

### Example 1 Preparation of Bio 1

An exemplary organic material treatment composition of the present application, Bio 1, was made by combining 1 kg of fruit skin (high citrus level fruit like orange, lemon and pineapple) together with 2 L of fermented rice water, 1 L of whole milk (non-pasteurized) 10 beaten eggs, and 10 L of molasses. The resulting mixture was fermented 15 days to 20 days at about 35° C. until the pH level falls below 4.0.

Fermented rice water was manufactured by washing about 2 kg of short grain rice with about 2 L of water for about 5 minutes. The rice is removed and the remaining starchy water was fermented at a temperature of about 30° C. to about 35° C. for about 72 hours or as required until a mold can be observed on the surface of the starchy water.

Other carbohydrate such as brown sugar can also be used instead of molasses.

### Example 2 Preparation of Bio 2

In a further example of an organic material treatment composition of the present application, Bio 2, was produced from Bio 1 described above. 1 L of Bio 1 was mixed with 19 L of Molasses in a container for 10 days at a temperature of about 21 degree Celsius to about 25 degrees Celsius).

Other types of carbohydrate can also be used instead of molasses.

### Example 3 Preparation of Liquid Fertilizer

The liquid fertilizer of the present application was produced in a three-chamber tank with a chamber volume proportion of 3:2:1. Organic material digestate was finely ground and added to the first chamber (largest chamber) along with Bio 2 and water. The organic material digestate can have a solid content of 4% to 30%. The ratios of the three components in the feed were 10% organic material digestate, 1% Bio 2 and 89% water. The bacteria Bacillus Pumilus and Bacillus Subtilis were then introduced into the first chamber at the ratio of 1 Kg each per 1000 liters of water. This slurry is kept at a constant 40 degrees Celsius and agitated continuously for a week. Subsequent addition of material in the first chamber caused an overflow into the second chamber. The contents of the second chamber were treated similarly to the first tank and were kept at 40 degrees Celsius and constantly agitated. The overflow from the second chamber filled the third smallest chamber of the tank. The contents of the third chamber were pumped out prior to the next addition of ingredients.

When the third chamber was pumped out, the resulting mixture was separated into a liquid fraction and a solid fraction. The liquid fraction was then heated to 70 degrees Celsius for 2 minutes to pasteurize the fertilizer. The solid fraction is sent back to the first tank for further processing.

The organic material digestate can be a product from any suitable digester, or mixtures of different digester products. Different digestates have been tested including digestate from a septic digester operating at 28° C. with a residence time of 35 days, the Toronto food digester operating at 30° C. to 35° C. with a residence time of 15 days, and a farm digester that is a combination of mesophilic/thermophilic digesters including two digesters operating at 28° C. in series with one digester operating at 55° C. to 58° C. (residence time of 50 days to 60 days).

Compositional analyses of the liquid fertilizer of the present application prepared from the septic digester digestate, the Toronto food digester and the farm digester using the method as described herein are presented in Example 12.

### Example 4 Use of the Liquid Fertilizer

The pasteurised liquid fertilizer obtained as described above can be used on for example soil and plants. An exemplary method of use is provided below.

The liquid fertilizer was diluted in a 1:200 ratio by mass or by volume with water. The resulting diluted fertilizer was sprayed on the leafy part of plants and/or on the soil within 72 hours of mixing. 1 L of the liquid fertilizer with 200 L water mixture was applied for about 1000 m² of soil and/or plants. The soil and/or plants were treated for about 10 to about 14 day intervals.

### Example 5 Use of Liquid Fertilizer on Mandeville Plants

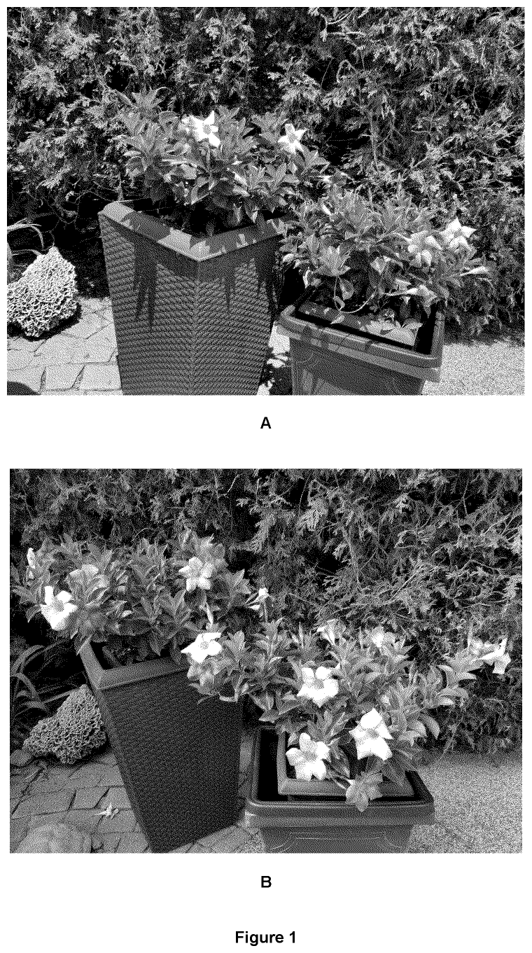

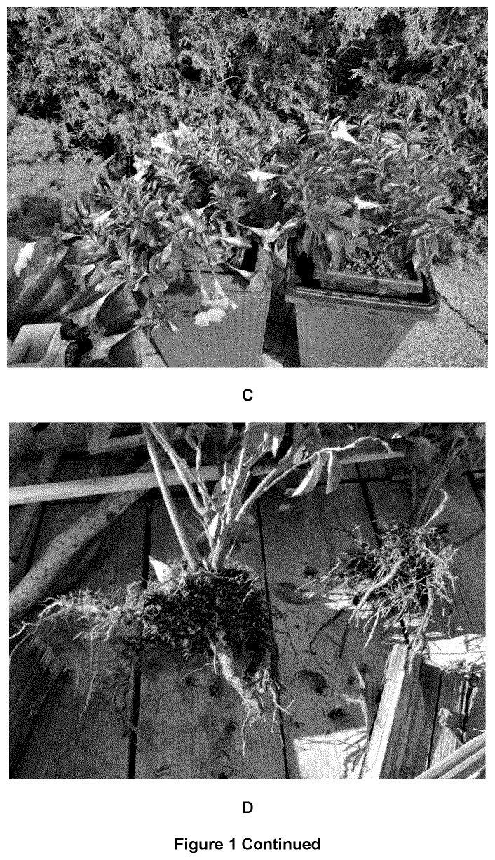

FIG. 1 shows two Mandeville plants treated with the commercially available fertilizer product 1 (made from non-digestate waste) or the liquid fertilizer of the present application made with digestate from the Toronto digester. The plant on the left was treated with the fertilizer of the present application, while the plant on the right was treated with the commercially available fertilizer. Both liquid fertilizers were diluted in water at a ratio of 1:100 per volume and applied to the plant every two weeks from mid-July to mid-September. Water was supplied to the plants every second or third day when no rain and in the same amounts for each plant. Pictures of the aerial portions of both plants were taken at end-July, mid-August, and mid-September. Pictures are shown in FIG. 1 Panels A, B, and C respectively. The plants were removed from the pots in mid-October. A picture was taken of the roots system of both plants and shown in FIG. 1 Panel D.

It was observed and shown in FIG. 1 that the plant treated with the fertilizer of the present application had larger and more flowers, as well as greener and larger leaves after one month. The plant treated with the fertilizer of the present application also exhibited larger root growth and root spread. The stem of the plant treated with the fertilizer of the present application was larger in diameter than that of the plant treated with commercial fertilizer.

### Example 6 Use of Liquid Fertilizer on Impatiens Plants

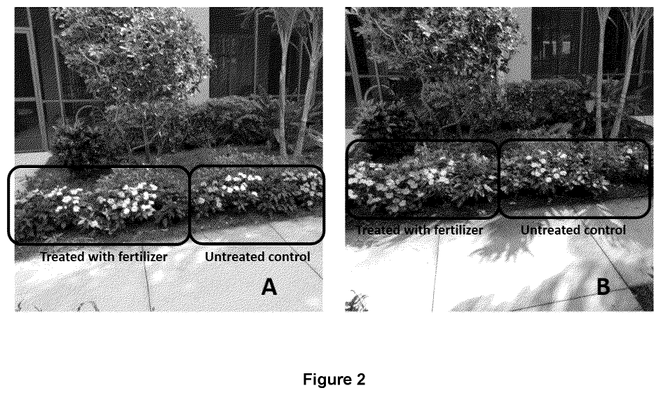

Liquid fertilizer of the present application made with digestate from farm waste (as described in above Examples) was used on Impatiens plants in Florida. FIG. 2 shows two groups of Impatiens plants, where the group of the left was treated with the liquid fertilizer of the present application and the group on the right received water only (as control) at the same time when the group on the left received the fertilizer. The liquid fertilizer was diluted with water at a ratio of 1:100 and applied every two weeks. The fertilizer application started at the beginning of February. Pictures were taken of both groups of plants at mid-February (Panel A) and end March (Panel B). The group of plants on the left treated with the fertilizer of the present application showed more sustained flowering and a higher number of flowers.

### Example 7 Analyses of Liquid Fertilizers of the Present Application

The liquid fertilizers of the present application prepared from septic digester digestate, Toronto food digester or farm digester using the method described in Examples 1 and 2 were tested by a third-party laboratory at Sir Sandford Fleming College. The results of the analyses are presented in Tables 1 to 3. Commercially available fertilizers including Inocucor™ fertilizer (Inocucor Additive in Table 4), Kentech™ fertilizer (Kentech Additive in Table 5), and Miracle Gro™ All-Purpose plant food (Table 6) were also tested for comparison.

As shown in tables below, Miracle Gro product, a solid chemical fertilizer, has significantly higher NPK values and Cr and Zn levels. It can be appreciated that a lower NPK value in fertilizers lead to lower leaching of nutrients into groundwater and thus lower runoff during rain events. Moreover, the liquid fertilizer product derived from digestate feedstock of the present application demonstrated 4 to 5 times higher TKN values and twice the K value compared to Inocucor and Kentech comparator samples.

TABLE 1
Liquid Fertilizer from Septic Digestate

| | Total | | | | | |
|---|---|---|---|---|---|---|
| Analyte | Coliform | E Coli | NO2-N | NO3-N | TKN-N | TP-P |
| Units | cfu/100 ml | cfu/100 ml | mg/L | mg/L | mg/L | mg/L |
| Values | <100 | <100 | 0.590 | 1.23 | 1760 | 239 |
| Methods | M548 | M548 | M532 | M532 | M533 | M534 |
| Reporting Limits | 100 (with | 100 (with | 0.006 | 0.02 | 0.16 | 0.01 |
| | 100× | 100× | | | | |
| | dilution), | dilution), | | | | |
| | LOD = 1 | LOD = 1 | | | | |
| Date Analyzed | 7 Jun. 2017 | 7 Jun. 2017 | 5 Jun. 2017 | 5 Jun. 2017 | 12 Jun. 2017 | 9 Jun. 2017 |
| Analyte | As | Cd | Co | Cu | Cr | Mo |
| Units | mg/L | mg/L | mg/L | mg/L | mg/L | mg/L |
| Values | 0.07 | 0.008 | 0.155 | 3.70 | 0.20 | 0.09 |
| Methods | M535 | M535 | M535 | M535 | M535 | M535 |
| Reporting Limits | 0.06 | 0.002 | 0.006 | 0.002 | 0.01 | 0.03 |
| Date Analyzed | 20 Jun. 2017 | 20 Jun. 2017 | 20 Jun. 2017 | 20 Jun. 2017 | 20 Jun. 2017 | 20 Jun. 2017 |
| Analyte | Ni | Pb | Se | Zn | Na | K |
| Units | mg/L | mg/L | mg/L | mg/L | mg/L | mg/L |
| Values | 0.26 | 0.08 | 0.04 | 4.45 | 1120 | 3730 |
| Methods | M535 | M535 | M535 | M535 | M535 | M535 |
| Reporting Limits | 0.01 | 0.02 | 0.04 | 0.01 | 0.05 | 0.06 |
| Date Analyzed | 20 Jun. 2017 | 20 Jun. 2017 | 20 Jun. 2017 | 20 Jun. 2017 | 20 Jun. 2017 | 20 Jun. 2017 |

TABLE 2
Liquid Fertilizer from Toronto Food Digester Digestate

| | | | | Reporting | Qualifier | |
|---|---|---|---|---|---|---|
| Analyte | Units | Values | Methods | Limit | Legend | Date Analyzed |
| Total Coliform | MPN/1 g as received | <1 | M558 | 1 | | 3 Oct. 2017 |
| Ecoli | MPN/1 g as received | <1 | M558 | 1 | | 3 Oct. 2017 |
| NO2-N | mg/L as N | 0.68 | M532 | 0.06 | RLHC | 5 Oct. 2017 |
| NO3-N | mg/L as N | 0.69 | M532 | 0.02 | RLHC | 5 Oct. 2017 |
| TP | mg/L as P | 394 | M534 | 0.01 | | 5 Oct. 2017 |
| | mg/Kg dry weight* | 7200 | M534 | n.a. | | 5 Oct. 2017 |
| TKN | mg/L | 2170 | M533 | 1.80 | RLHR | 5 Oct. 2017 |
| | mg/Kg dry weight* | 39700 | M533 | n.a. | | 5 Oct. 2017 |
| Potassium | mg/L | 4380 | M535 | 0.3 | RLHR | 16 Oct. 2017 |
| | mg/Kg dry weight* | 80100 | M535 | n.a. | | 16 Oct. 2017 |
| Sodium | mg/L | 621 | M535 | 0.25 | RLHR | 16 Oct. 2017 |
| | mg/Kg dry weight* | 11400 | M535 | n.a. | | 16 Oct. 2017 |
| Magnesium | mg/L | 460 | M535 | 0.45 | RLHR | 16 Oct. 2017 |
| | mg/Kg dry weight* | 8420 | M535 | n.a. | | 16 Oct. 2017 |
| Arsenic | mg/L | 0.080 | M535 | 0.03 | | 16 Oct. 2017 |
| | mg/Kg dry weight* | 1.54 | M535 | n.a. | | 16 Oct. 2017 |
| Cadium | mg/L | 0.013 | M535 | 0.001 | | 16 Oct. 2017 |
| | mg/Kg dry weight* | 0.240 | M535 | n.a. | | 16 Oct. 2017 |
| Cobalt | mg/L | 0.062 | M535 | 0.00 | | 16 Oct. 2017 |
| | mg/Kg dry weight* | 1.14 | M535 | n.a. | | 16 Oct. 2017 |
| Copper | mg/L | 9.59 | M535 | 0.001 | | 16 Oct. 2017 |
| | mg/Kg dry weight* | 175 | M535 | n.a. | | 16 Oct. 2017 |
| Chromium | mg/L | 0.163 | M535 | 0.005 | | 16 Oct. 2017 |
| | mg/Kg dry weight* | 2.99 | M535 | n.a. | | 16 Oct. 2017 |
| Molybdenum | mg/L | 0.138 | M535 | 0.015 | | 16 Oct. 2017 |
| | mg/Kg dry weight* | 2.52 | M535 | n.a. | | 16 Oct. 2017 |
| Nickel | mg/L | 0.214 | M535 | 0.005 | | 16 Oct. 2017 |
| | mg/Kg dry weight* | 3.91 | M535 | n.a. | | 16 Oct. 2017 |
| Lead | mg/L | 0.080 | M535 | 0.010 | | 16 Oct. 2017 |
| | mg/Kg dry weight* | 1.50 | M535 | n.a. | | 16 Oct. 2017 |
| Selenium | mg/L | 0.030 | M535 | 0.020 | | 16 Oct. 2017 |
| | mg/Kg dry weight* | 0.590 | M535 | n.a. | | 16 Oct. 2017 |
| Zinc | mg/L | 11.1 | M535 | 0.005 | | 16 Oct. 2017 |
| | mg/Kg dry weight* | 203 | M535 | n.a. | | 16 Oct. 2017 |

RLHC: reporting limit raised- dilution required due to color interference
RLHR: reporting limit raised- dilution required due to high range of analyte
TP and TKN values reported in mg/kg dry weight were calculated using total solids, density and mg/L

TABLE 3
Liquid Fertilizer from Farm Digester Digestate

| | | | | Reporting | Qualifier | |
|---|---|---|---|---|---|---|
| Analyte | Units | Values | Methods | Limit | Legend | Date Analyzed |
| C:N ratio | No unit | 9.8 | M554 | n.a. | | 4 Oct. 2017 |
| Total solids | % | 3.4 | M561 | n.a. | | 6 Oct. 2017 |
| Volatile solids | % | 2.3 | M561 | n.a. | | 6 Oct. 2017 |
| TP | mg/L as P | 309 | M534 | 0.01 | | 5 Oct. 2017 |
| | mg/Kg dry weight* | 8980 | M534 | n.a. | | 5 Oct. 2017 |
| TKN | mg/L | 3389 | M533 | 1.80 | RLHR | 5 Oct. 2017 |
| | mg/Kg dry weight* | 98400 | M533 | n.a. | | 5 Oct. 2017 |

RLHR: reporting limit raised- dilution required due to high range of analyte
TP and TKN values reported in mg/kg dry weight were calculated using total solids, density and mg/L

TABLE 4
Inocucor Fertilizer
Sample Name Inocucor Additive
Date Sampled Unknown
Date Received Jun. 1, 2017

| | Total | | | | | |
|---|---|---|---|---|---|---|
| Analyte | Coliform | E Coli | NO2-N | NO3-N | TKN-N | TP-P |
| Units | cfu/100 ml | cfu/100 ml | mg/L | mg/L | mg/L | mg/L |
| Values | n.a. | n.a. | 0.300 | 0.580 | 540 | 117 |
| Methods | M548 | M548 | M532 | M532 | M533 | M534 |
| Reporting Limits | n.a. | n.a. | 0.006 | 0.02 | 0.16 | 0.01 |
| Date Analyzed | n.a. | n.a. | 5 Jun. 2017 | 5 Jun. 2017 | 12 Jun. 2017 | 9 Jun. 2017 |

| Analyte | As | Cd | Co | Cu | Cr | Mo |
|---|---|---|---|---|---|---|
| Units | mg/L | mg/L | mg/L | mg/L | mg/L | mg/L |
| Values | 0.08 | 0.019 | 0.015 | 1.39 | 0.06 | 0.07 |
| Methods | M535 | M535 | M535 | M535 | M535 | M535 |
| Reporting Limits | 0.06 | 0.002 | 0.006 | 0.002 | 0.01 | 0.03 |
| Date Analyzed | 20 Jun. 2017 | 20 Jun. 2017 | 20 Jun. 2017 | 20 Jun. 2017 | 20 Jun. 2017 | 20 Jun. 2017 |
| Analyte | Ni | Pb | Se | Zn | Na | K |
| Units | mg/L | mg/L | mg/L | mg/L | mg/L | mg/L |
| Values | 0.05 | <0.02 | <0.04 | 0.85 | 344 | 2080 |
| Methods | M535 | M535 | M535 | M535 | M535 | M535 |
| Reporting Limits | 0.01 | 0.02 | 0.04 | 0.01 | 0.05 | 0.06 |
| Date Analyzed | 20 Jun. 2017 | 20 Jun. 2017 | 20 Jun. 2017 | 20 Jun. 2017 | 20 Jun. 2017 | 20 Jun. 2017 |

TABLE 5
Kentech Fertilizer
Sample Name Kentech Additive
Date Sampled Unknown
Date Received Jun. 1, 2017

| | Total | | | | | |
|---|---|---|---|---|---|---|
| Analyte | Coliform | E Coli | NO2-N | NO3-N | TKN-N | TP-P |
| Units | cfu/100 ml | cfu/100 ml | mg/L | mg/L | mg/L | mg/L |
| Values | n.a. | n.a. | 0.080 | 0.500 | 873 | 235 |
| Methods | M548 | M548 | M532 | M532 | M533 | M534 |
| Reporting Limits | n.a. | n.a. | 0.006 | 0.02 | 0.16 | 0.01 |
| Date Analyzed | n.a. | n.a. | 5 Jun. 2017 | 5 Jun. 2017 | 12 Jun. 2017 | 9 Jun. 2017 |

| Analyte | As | Cd | Co | Cu | Cr | Mo |
|---|---|---|---|---|---|---|
| Units | mg/L | mg/L | mg/L | mg/L | mg/L | mg/L |
| Values | <0.06 | 0.009 | 0.029 | 0.176 | 0.18 | <0.03 |
| Methods | M535 | M535 | M535 | M535 | M535 | M535 |
| Reporting Limits | 0.06 | 0.002 | 0.006 | 0.002 | 0.01 | 0.03 |
| Date Analyzed | 20 Jun. 2017 | 20 Jun. 2017 | 20 Jun. 2017 | 20 Jun. 2017 | 20 Jun. 2017 | 20 Jun. 2017 |
| Analyte | Ni | Pb | Se | Zn | Na | K |
| Units | mg/L | mg/L | mg/L | mg/L | mg/L | mg/L |
| Values | 0.28 | <0.02 | <0.04 | 14.4 | 470 | 1210 |
| Methods | M535 | M535 | M535 | M535 | M535 | M535 |
| Reporting Limits | 0.01 | 0.02 | 0.04 | 0.01 | 0.05 | 0.06 |
| Date Analyzed | 20 Jun. 2017 | 20 Jun. 2017 | 20 Jun. 2017 | 20 Jun. 2017 | 20 Jun. 2017 | 20 Jun. 2017 |

TABLE 6
Miracle Gro All-Purpose Plant Food
Sample Name Miracle Gro all-purpose plant food
Date Sampled Unknown
Date Received Jun. 6, 2017

| | Total | | | | | |
|---|---|---|---|---|---|---|
| Analyte | Coliform | E Coli | NO2-N | NO3-N | TKN-N | TP-P |
| Units | cfu/100 ml | cfu/100 ml | mg/L | mg/L | mg/L | mg/L |
| Values | <400 | <400 | 0.110 | 3.62 | 143000 | 20900 |
| Methods | M548 | M548 | M532 | M532 | M533 | M534 |
| Reporting Limits | 400 (with | 400 (with | 0.006 | 0.02 | 0.16 | 0.01 |
| | 400× | 400× | | | | |
| | dilution), | dilution), | | | | |
| | LOD = 1 | LOD = 1 | | | | |
| Date Analyzed | 7 Jun. 2017 | 7 Jun. 2017 | 7 Jun. 2017 | 7 Jun. 2017 | 12 Jun. 2017 | 9 Jun. 2017 |
| Analyte | As | Cd | Co | Cu | Cr | Mo |
| Units | mg/L | mg/L | mg/L | mg/L | mg/L | mg/L |
| Values | <0.30 | 0.07 | <0.03 | <0.01 | 0.69 | <0.15 |
| Methods | M535 | M535 | M535 | M535 | M535 | M535 |
| Reporting Limits | 0.30 | 0.01 | 0.03 | 0.01 | 0.01 | 0.15 |
| Date Analyzed | 20 Jun. 2017 | 20 Jun. 2017 | 20 Jun. 2017 | 20 Jun. 2017 | 20 Jun. 2017 | 20 Jun. 2017 |
| Analyte | Ni | Pb | Se | Zn | Na | K |
| Units | mg/L | mg/L | mg/L | mg/L | mg/L | mg/L |
| Values | <0.05 | <0.10 | <0.20 | 632 | 4100 | 83600 |
| Methods | M535 | M535 | M535 | M535 | M535 | M535 |
| Reporting Limits | 0.05 | 0.10 | 0.20 | 0.01 | 0.05 | 0.06 |
| Date Analyzed | 20 Jun. 2017 | 20 Jun. 2017 | 20 Jun. 2017 | 20 Jun. 2017 | 20 Jun. 2017 | 20 Jun. 2017 |

### Example 8 Analysis of Liquid Fertilizer of the Present Application

Animal waste digestate from the Toronto Zoo digester was used to prepare a liquid fertilizer using a method of the present application as described above for example in Example 3. The resulting liquid fertilizer was analysed by a third party laboratory (A&L Canada Laboratories Inc., London, Ontario) for its contents to show components useful as a fertilizer. The analysis results are shown in Table 7. As shown, the method of the present application can be used with animal waste digestate including zoo animal (e.g. exotic animal waste) waste digestate to produce liquid fertilizers.

TABLE 7
Fertilizer/Lime Analysis of Liquid Fertilizer Prepared
from Toronto Zoo Animal Waste Digestate

| | | | DETECTION | |
|---|---|---|---|---|
| PARAMETER | RESULT | UNIT | LIMIT | METHOD REFERENCE |
| Nitrogen (Total) | 0.34 | % | 0.10 | ENV-G-003-6 * |
| Phosphorus (Available P205) | BDL | % | 0.1 | AOAC 993.31(mod)* |
| Potassium (Soluble K20) | BDL | % | 0.1 | AOAC 983.02(mod)* |
| Aluminum | BDL | ug/g | 5.00 | ICP |
| Boron | 7.75 | ug/g | 1.00 | EPA 3050B/6010 (mod) |
| Calcium | 0.19 | % | 0.01 | ICP |
| Copper | 11.64 | ug/g | 1.00 | ICP |
| Iron | 261.79 | ug/g | 5.00 | EPA 3050B/6010 (mod) |
| Magnesium | 0.04 | % | 0.01 | ICP |
| Manganese | BDL | ug/g | 1.00 | EPA 3050B/6010 (mod) |
| Phosphorus | 220.56 | ug/g | 5.00 | ICP |
| Potassium | 1815.02 | ug/g | 5.00 | ICP |
| Sodium | 1898.88 | ug/g | 1.00 | ICP |
| Sulphur | 0.05 | % | 0.01 | ICP |
| Zinc | 4.96 | ug/g | 1.00 | ICP |

*accredited test

While the present application has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

1. Method of treating an organic material digestate and/or producing a liquid fertilizer comprising
mixing an organic material treatment composition, the organic material digestate, and water to obtain an organic digestate mixture; and
incubating and agitating the organic digestate mixture for about 15 days to about 25 days at about 30° C. to about 50° C. to treat the organic material digestate and/or produce the liquid fertilizer;
wherein the organic material treatment composition comprises
fruit skin;
fermented rice water;
milk;
eggs; and
a first carbohydrate;
and wherein the organic material treatment composition has a pH of about 4 or less than 4.

2. Method of treating an organic material digestate and/or producing a liquid fertilizer comprising
combining fruit skin, fermented rice water, milk, eggs, and a first carbohydrate to obtain a first mixture;
incubating and agitating the first mixture for about 10 days to about 25 days at about 30° C. to about 40° C. until a pH value of about 4 or less than 4 is obtained to obtain an organic material treatment composition;
mixing the organic material treatment composition, an organic material digestate, and water to obtain an organic digestate mixture; and
incubating and agitating the organic digestate mixture for about 15 days to about 25 days at about 30° C. to about 50° C. to treat the organic material digestate and/or produce the liquid fertilizer.

3. (canceled)

4. (canceled)

5. The method of claim 1, wherein the fruit skin is skin from fruits comprising ascorbic acid and/or citric acid.

6. The method of claim 1, wherein the fruit skin is selected from skin from citrus fruit, pineapple, mango, papaya, dragon fruit, dates, lychee, tamarind, and mixtures thereof.

7. (canceled)

8. (canceled)

9. The method of claim 18, wherein the fermented rice water is fermented for about 50 hours to about 90 hours at a temperature of about 25° C. to about 40° C.

10. (canceled)

11. (canceled)

12. (canceled)

13. (canceled)

14. The method of claim 1, wherein the eggs are poultry eggs.

15. (canceled)

16. (canceled)

17. The method of claim 1, wherein the first carbohydrate is selected from molasses, brown sugar, white sugar, cane sugar, honey, corn syrup, and mixtures thereof.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. The method of claim 1, wherein the organic material treatment composition comprises
about 5 wt % to about 5.5 wt % of the fruit skin;
about 9 wt % to about 12 wt % of the fermented rice water;
about 5 wt % to about 5.5 wt % of the milk;
about 1.5 wt % to about 4.5 wt % of the eggs; and
about 70 wt % to about 80 wt % of the first carbohydrate.

30. The method of claim 2, wherein the incubating and agitating of the first mixture further comprises combining the incubated and agitated first mixture with a second carbohydrate and at least one selected from water, an organic waste leachate and mixtures thereof to obtain a second mixture, and incubating and agitating the second mixture for 5 days to 15 days at about 20° C. to about 28° C. to obtain the organic material treatment composition.

31. (canceled)

32. (canceled)

33. (canceled)

34. (canceled)

35. (canceled)

36. (canceled)

37. (canceled)

38. (canceled)

39. The method of claim 30, wherein the second carbohydrate is selected from molasses, brown sugar, white sugar, cane sugar, honey, corn syrup, and mixtures thereof.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. The method of claim 30, wherein the organic material treatment composition comprises
about 1 wt % to about 1.7 wt % of the fruit skin;
about 2 wt % to about 3 wt % of the fermented rice water;
about 1 wt % to about 1.7 wt % of the milk;
about 0.3 wt % to about 1 wt % of the eggs;
about 15 wt % to about 20 wt % of the first carbohydrate;
about 15 wt % to about 20 wt % of the second carbohydrate; and
balance water.

56. The method of claim 1, wherein the organic material digestate is a digestate of an organic waste selected from food waste, sewage waste, septic tank sludge, agricultural waste, farming waste, supermarket waste, restaurant waste, grocery store waste, food processing waste, animal manures, silage waste, composting waste, and mixtures thereof.

57. (canceled)

58. The method of claim 1, wherein the organic material digestate is an aerobic digestate.

59. The method of claim 1, wherein the organic material digestate is an anaerobic digestate, and the anaerobic digestate is aerated prior to the mixing with the organic material treatment composition and the water, optionally the aerating is performed with air injection.

60. (canceled)

61. (canceled)

62. The method of claim 59, wherein the anaerobic digestate is animal manures digestate, silage waste digestate, food processing waste digestate, composting waste digestate, septic waste digestate, farm waste digestate, or mixtures thereof, and has been digested in an anaerobic digester for about 15 days to about 50 days.

63. (canceled)

64. (canceled)

65. (canceled)

66. (canceled)

67. (canceled)

68. The method of claim 1, wherein the organic material digestate represents about 60 v/v % to about 90 v/v % of the total weight of the organic digestate mixture, the organic material treatment composition represents about 10 v/v % to about 40 v/v % of the total weight of the organic digestate mixture.

69. (canceled)

70. (canceled)

71. (canceled)

72. The method of claim 1, further comprising pasteurizing the incubated and agitated organic digestate mixture.

73. (canceled)

74. (canceled)

75. The method of claim 1, further comprising prior to incubating and agitating the organic digestate mixture, contacting the organic digestate mixture with a bacterial culture comprising Bacillus bacteria prior to the incubating and agitating, optionally, the organic material mixture is contacted with about 0.5 g to about 1.5 g of the bacterial culture per liter of water in the organic material mixture.

76. (canceled)

77. A liquid fertilizer produced by a method as defined in claim 75.

78. (canceled)

79. (canceled)

80. (canceled)

81. (canceled)

82. Method of enhancing plant growth or for providing nutrients to a soil in need thereof comprising contacting a plant with a liquid fertilizer as defined in claim 75.

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)
